(19) United States
(12) Patent Application Publication
(10) Pub. No.: US 2006/0103889 A1
(43) Pub. Date: May 18, 2006

(54) Image forming apparatus, image forming process and image forming program

(75) Inventors: Toru Adachi, Nara (JP); Kohsuke Harada, Nara (JP); Hiroshi Tanaka, Nara (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/280,584

(22) Filed: Nov. 15, 2005

(30) Foreign Application Priority Data
Nov. 16, 2004 (JP) 2004-332152
Jul. 19, 2005 (JP) 2005-208218

(51) Int. Cl. H04N 1/41

(52) U.S. Cl. 358/426.04

(57) ABSTRACT

An image forming one which is capable of shortening the first copy time and equalizing the image qualities of a plurality of all output copies when a plurality of copies of the original document are output using the memory copy function is provided. An image data of each one line of an original document is sequentially read by a scanner unit. Whenever the image data of a given portion of the original document less than one page thereof (for example, image data of 8 lines) is accumulated, it is subjected to irreversible compression in a compressing circuit. The irreversible compressed image data which is obtained by this irreversible compression is sequentially stored in a storage area of an image memory or HDD and thereafter is sequentially decompressed in a decompressing circuit. Image forming is sequentially conducted based upon the sequentially decompressed image data in a printing device.

### CROSS-NOTING PARAGRAPH

This non-provisional application claims priority under 35 U.S.C. §119(a) on Patent Applications No. 2004-332152 filed in JAPAN on Nov. 16, 2004, and No. 2005-208218 filed in JAPAN on Jul. 19, 2005, the entire contents of which are hereby incorporated herein by reference.

### FIELD OF THE INVENTION

The present invention relates to an image forming apparatus and image forming process and in particular to an image forming apparatus, image forming process and image forming program which are capable of reproducing a plurality of copies by reading the images on an original document once by forming images on a transfer sheet based upon image data which is stored in a given storage portion, that is, have a memory copying function.

### BACKGROUND OF THE INVENTION

A prior art image forming apparatus (refer to Japanese Laid-Open Patent Publication No. 9-224106) which is capable of shortening the period of time taken until a first copy is discharged (hereinafter referred to as “first copy time”) will be described with reference to a block diagram of FIG. 1. FIG. 1 is a block diagram explaining the image forming processing (refer to FIG. 1 of Japanese Laid-Open Patent Publication No. 9-224106).

In FIG. 1, a reference numeral 1 denotes a scanner; 2 a printer; 3 a control panel; and 4 a system control unit. The system control unit 4 comprises an image processing portion 4a, transmission path switching portion 4b, data compressing portion 4c, image memory 4d, data decompressing portion 4e, data transferring portion 4f, and main control unit 4g. The system control unit 4 has a path for compressing data which is read by the scanner 1 and for storing the read data in the image memory 4d and a path for outputting data to the printer 2 without passing it through the data compressing portion 4c and the data decompressing portion 4e and the like. This causes the data for the first copy to be printed without passing it through the data compressing portion 4c and data decompressing portion 4e to achieve speeding up of the first copying.

However, the image forming apparatus disclosed in the foregoing Japanese Laid-Open Patent Publication No. 9-224106 has a path for storing the image data in an image memory and a path for outputting the image data to the printer without passing it through the data compressing and decompressing portions. Since the data for the first copy is printed without being passed through the data compressing and decompressing portions whereas the data for the second copy is passed through the data compressing and decompressing portions and is printed, there is a problem that when irreversible compression is used in the data compressing portion, the first copy is different from the second and subsequent copies in their image qualities. On the other hand, if reversible compression is used in the data compressing portion in order to make the image quality of the first copy equal to that of the second and subsequent copies, a higher capacity of image memory is necessary, resulting in a high cost since the compression rate will become lower in comparison with the irreversible compression.

### SUMMARY OF THE INVENTION

It is an object of the present invention to provide an image forming apparatus, image forming process and image forming program which is capable of shortening the fist copy time when a plurality of copies of an original document are reproduced by a memory copy function and of equalizing the image qualities of all plurality of copies.

The present invention can be applied to an image forming apparatus having a so-called memory copy function, comprising:

an image data compressing portion for applying at least an irreversible compression processing to the image data, which is obtained each time when the given portion of the original document less than one page of original document, is read;

an image data storing portion for sequentially storing in the storage portion such as image memory or HDD irreversible compressed image data which is sequentially irreversible compressed by the image data compressing portion;

an image data decompressing portion for sequentially decompressing the irreversible compressed image data which is sequentially stored by the image data storing portion; and

an image forming portion for sequentially forming images on a sheet of paper based upon the image data decompressed by the image data decompressing portion;

wherein the image data compressing portion, the image data storing portion and the image data decompressing portion are operated in parallel.

Since each processing such as compression, storing, decompression and image forming are sequentially conducted prior to the completion of reading of the images on one page of an original document in such a configuration, the first copy time can be shortened. Additionally, since the image forming for the first, second and subsequent copies is conducted based upon the image data (hereinafter referred to as “decompressed image data”) which is obtained by the decompression of the image data which is subjected to irreversible compression processing (hereinafter referred to as “irreversible compressed image data”), no difference in image quality among all memory output reproduced copies. In other words, the image quality preferably becomes equal among all the memory output copies.

In accordance with the present invention, an image forming apparatus may comprise the image data compressing portion; the image data storing portion; the image data decompressing portion; a storing and decompression processing portion which conducts the storing by the image data storing portion and the decompression by the image data decompressing portion in parallel for the irreversible compressed image data which is obtained by the image data compressing portion; and the image forming portion, wherein the image data compressing portion and the storing and decompression processing portion may be operated in parallel.

Since the storing of the compressed irreversible compressed image data in the storage portion is conducted in parallel with the decompression processing of the irreversible compressed image data in such a configuration (that is, processed in parallel), the processing speed is improved and further shortening of the fist copy time can be achieved.

The present invention is applied to an image forming process which achieves the so-called memory copy function. In the image forming process, a first reproduction process for reproducing a first copy of the original document comprises an image data compressing step for sequentially applying at least an irreversible compression processing to the image data of a given portion of the original document which is obtained each time when the given portion of the original document less than one page thereof is read; an image data storing step for sequentially storing in the storage portion irreversible compressed image data which is obtained by sequentially applying the irreversible compression processing to the image data of the given portion of the original document by the image data compressing step; an image data decompressing step for sequentially decompressing the irreversible compressed image data which is sequentially stored in the storage portion at the image data storing step and an image forming step for sequentially forming images on a sheet of paper based upon the decompressed image data which is obtained by sequentially decompressing the irreversible compressed image data at the image data decompressing step, and a second process for reproducing a second and subsequent copies of the original document comprises the image data decompressing step and the image forming step.

By means of such a process, each processing including compression, storage, decompression and image forming are sequentially conducted for the image data of a given portion of an original document when the given portion of the original document less than one page thereof is read and the first copy time can be shortened. Since the image forming for the first and second and subsequent copies is conducted based upon the decompressed image data which is obtained by the decompression of the irreversible compressed image data which is subjected to the irreversible compression process, there is no difference in image quality between all memory output copies. In other words, the all memory output copies are preferably equal in image quality.

By the way, one of the compression processing formats which is adopted in the image forming apparatus is a JPEG format compression processing (hereinafter referred to as “JPEG compression processing”). The JPEG compression processing applies irreversible compression processing to the read image data and further applies reversible compression processing to the irreversible compressed image data which is obtained after the irreversible compression processing. In accordance with the present invention, the image forming apparatus and image forming process which adopt a compression processing including processing for irreversibly compressing the read image data (irreversible compression processing) and reversible compression processing for further reversibly compressing the irreversible compressed image data which is obtained by sequentially applying the irreversible compression processing. When a first copy of the original document is output in this image forming apparatus and process, only irreversible data decompression processing which decompresses the irreversible compressed image data which was irreversible compressed in image data decompressing is applied and reversible data decompression processing which decompresses the reversibly compressed image data is omitted. Therefore, the processing period of time which is taken to conduct the reversible data decompression processing can be shortened and burden of processing can be reduced.

As a specific example of the irreversible data compression processing, an irreversible compression processing sequentially executes YUV transform processing, DCT processing and quantization processing can be given. As a specific example of the reversible compression processing, Huffman coding processing can be given. As a specific example of the irreversible data decompression processing, an irreversible data decompression processing which conduct dequantization processing, deDCT processing and RGB conversion processing can be given. As a specific example of the reversible data decompression processing, Huffman decoding processing can be given.

At this time, it can be considered that dequantization processing, deDCT processing and RGB conversion processing may be sequentially conducted in the image data decompressing step in the first copy reproducing step of the image forming process, and Huffman decoding processing, dequantization processing, deDCT processing and RGB conversion processing may be sequentially conducted in the image data decompressing step in the second copy reproducing process. Consequently, the processing period of time which is taken for the Huffman decoding processing can be shortened at the image data decompressing step in the first copy process, and further shortening of the fist copy time can be achieved.

Alternatively, the present invention further provides an image forming program for causing a computer to execute each step in the image forming process.

### BRIEF DESCRIPTION OF THE DRAWINGS

FIG. 1 is a block diagram explaining a prior art (technique disclosed in Japanese Laid-Open Patent Publication No. 9-224106) for shortening the first copy time;

FIG. 2 is a front view showing the schematic structure of the image forming apparatus of an embodiment of the present invention;

FIG. 3 is a block diagram showing the schematic structure of a control system of the image forming apparatus shown in FIG. 2;

FIG. 4 is a block diagram showing the schematic structure of an image processing system of the image forming apparatus shown in FIG. 2;

FIG. 5 is a timing chart explaining an example of a process for reproducing a first copy using a memory copy function, which is conducted by the control system and the image processing system of the image forming apparatus shown in FIG. 2;

FIG. 6 is a timing chart explaining an example of a process for reproducing second and subsequent copies using a memory copy function, which is conducted by the control system and the image processing system of the image forming apparatus shown in FIG. 2;

FIG. 7 is a block diagram showing another schematic structure of an image processing system of the image forming apparatus shown in FIG. 2;

FIG. 8 is a timing chart explaining another example of a process for reproducing a first copy using a memory copy function, which is conducted by the control system and the image processing system of the image forming apparatus shown in FIG. 2;

FIG. 9 is a block diagram showing another schematic structure example of an image processing system of the image forming apparatus shown in FIG. 2;

FIG. 10 is a timing chart explaining another example of a process for reproducing a first copy using a memory copy function, which is conducted by the control system and the image processing system of the image forming apparatus shown in FIG. 2;

FIG. 11 is a timing chart explaining another example of a process for reproducing second and subsequent copies using a memory copy function, which is conducted by the control system and the image processing system of the image forming apparatus shown in FIG. 2;

FIG. 12 is a view explaining one unit of read image data;

FIG. 13A is a flow chart explaining an example of the reproducing process using the memory copy function which is conducted by the control portion;

FIG. 13B is a flow chart explaining an example of the reproducing process using the memory copy function which is conducted by the image processing control portion;

FIG. 14A is a flow chart explaining one example of the compression processing;

FIG. 14B is a flow chart explaining one example of the decompression processing for first copy; and

FIG. 14C is a flow chart explaining one example of the decompression processing for second and subsequent copies.

### PREFERRED EMBODIMENTS OF THE INVENTION

Embodiments and examples of the present invention will be described below with reference to annexed drawings for more understanding of the present invention. The embodiments and examples which will be described thereafter are merely illustrative cases and will not restrict the technical scope of the present invention.

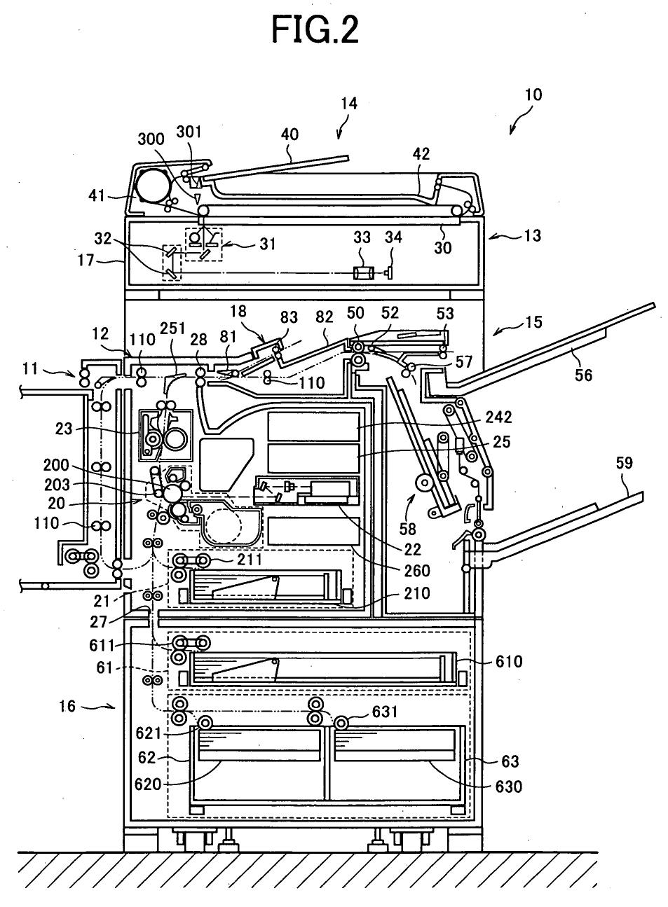

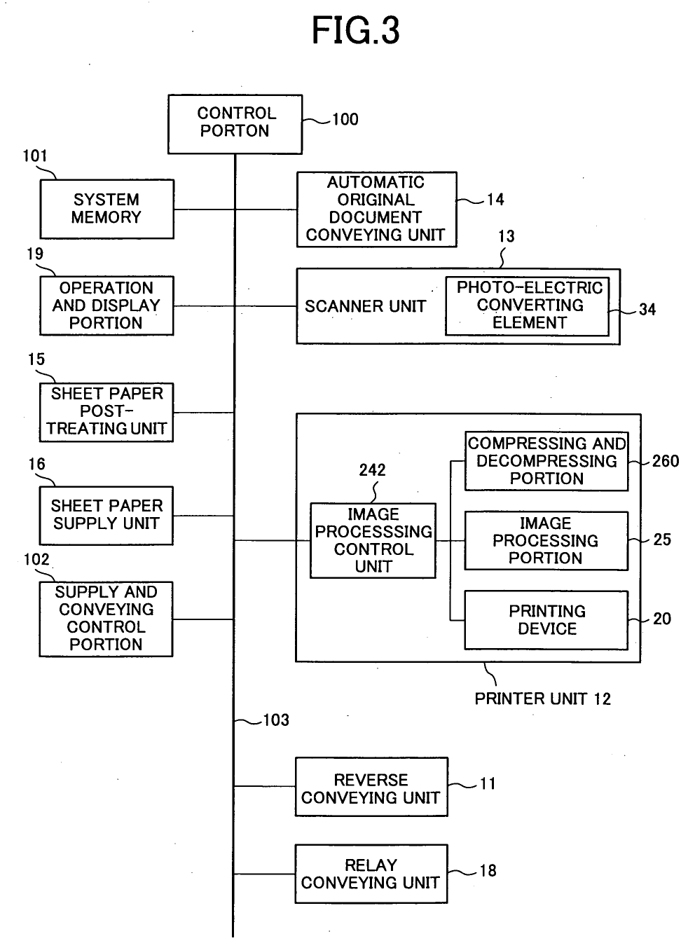

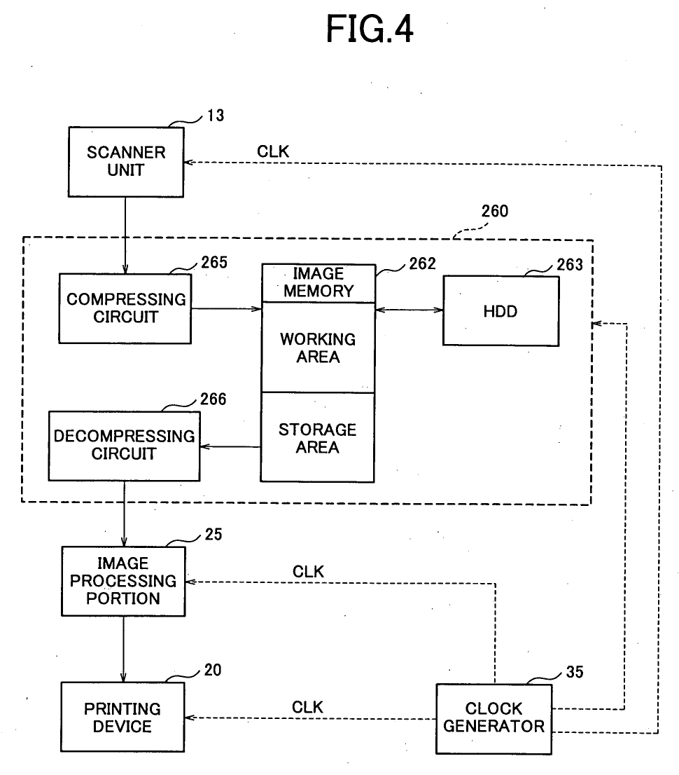

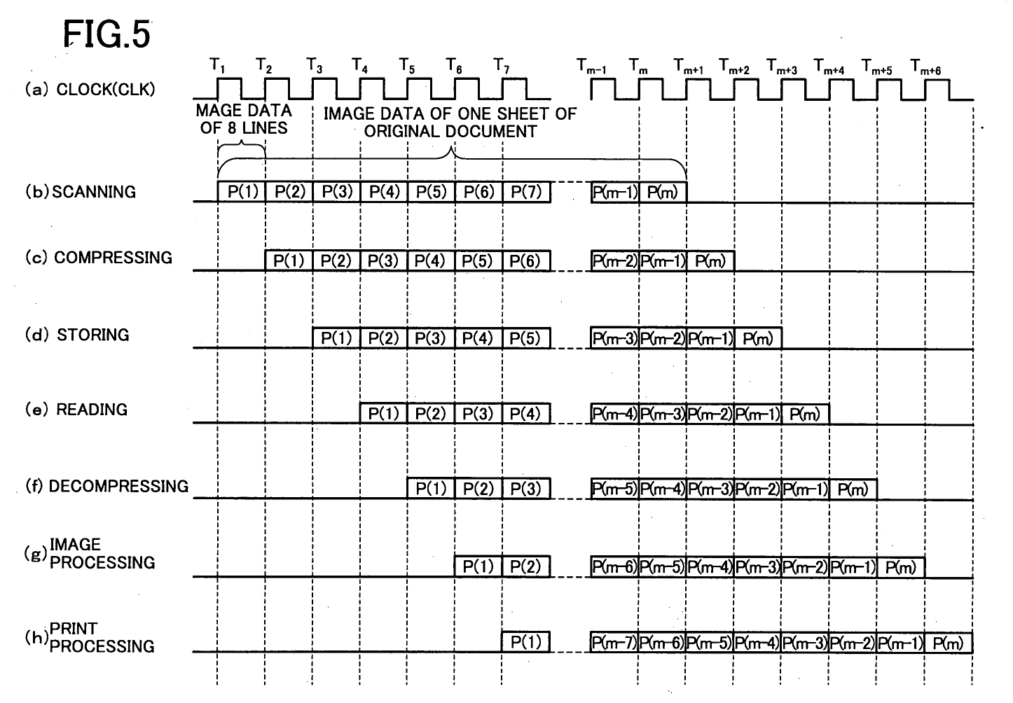

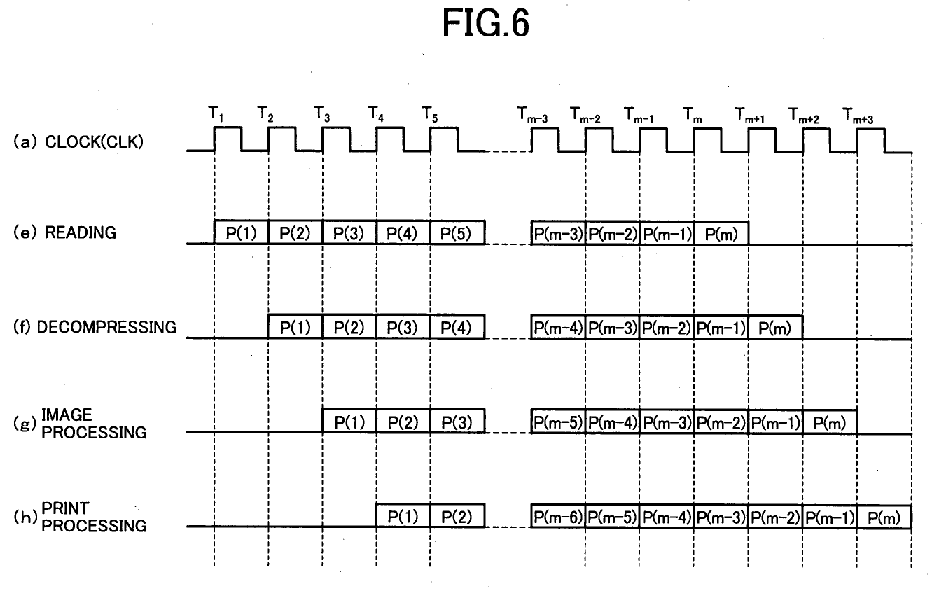

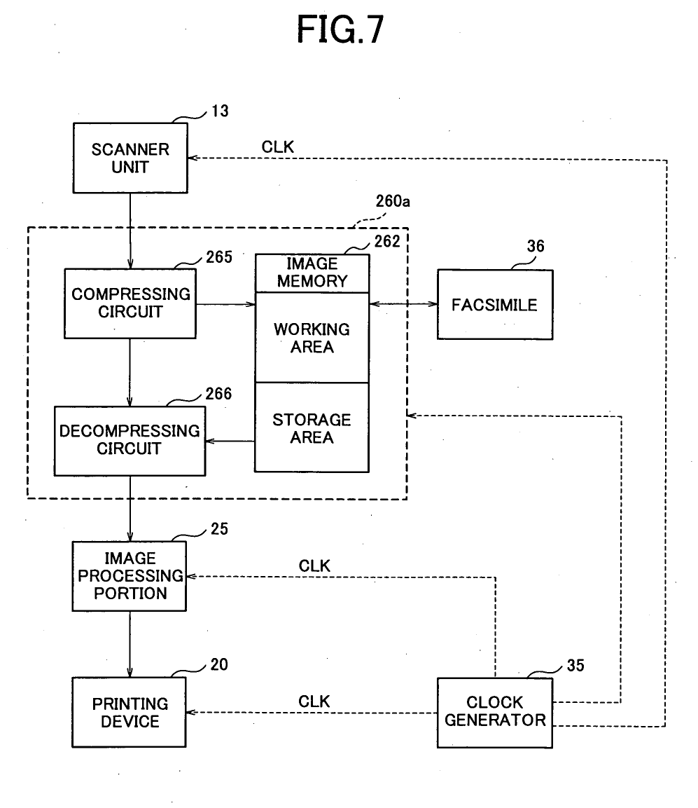

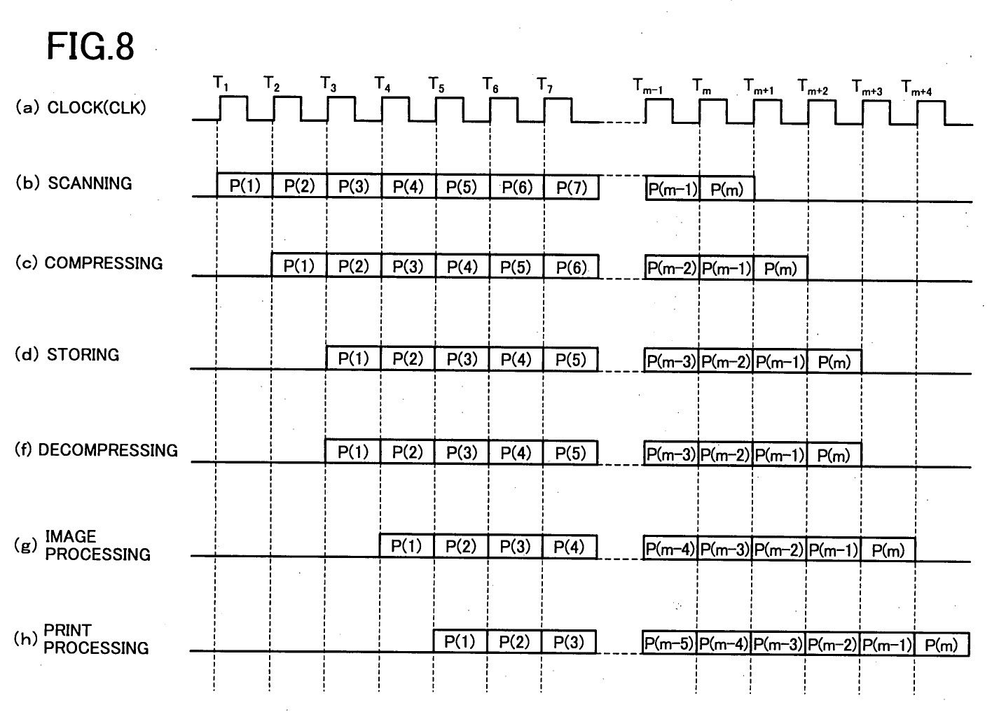

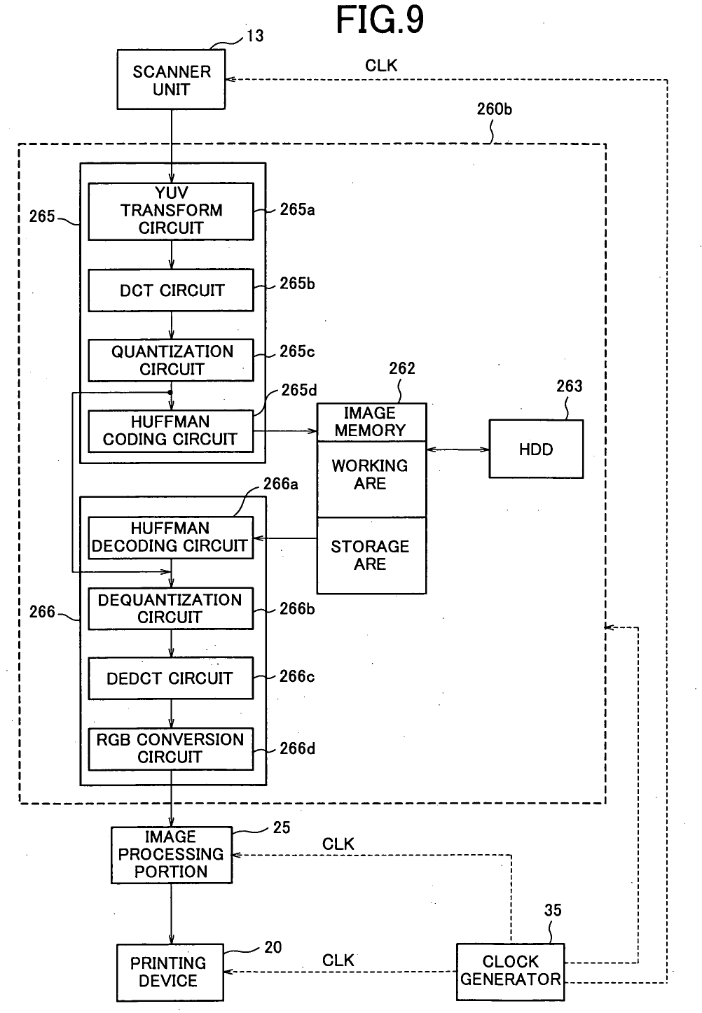

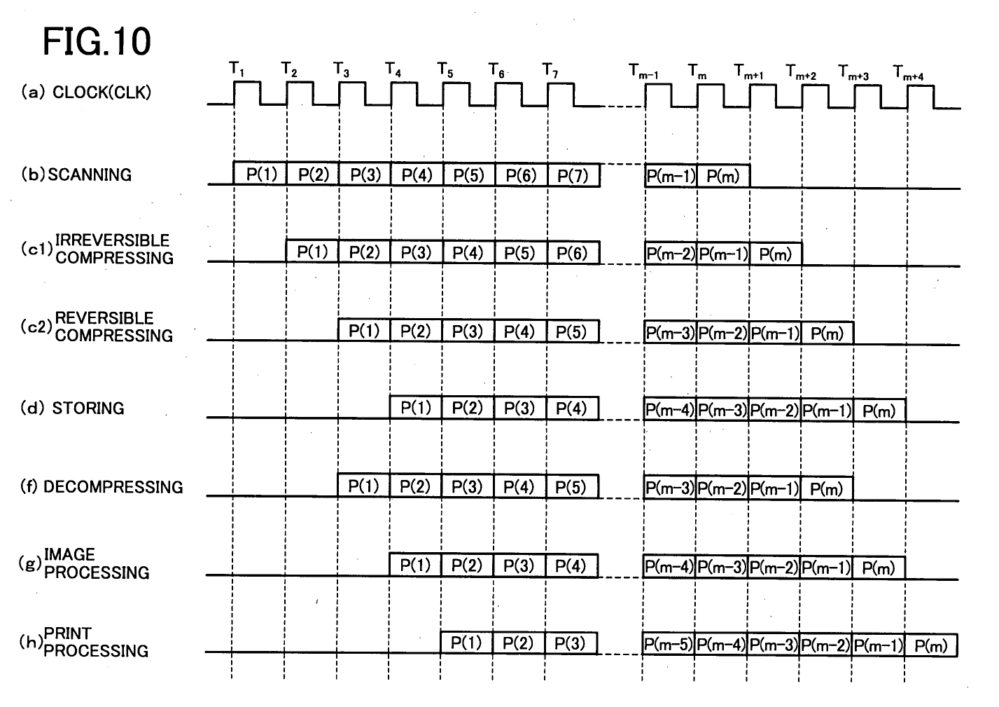

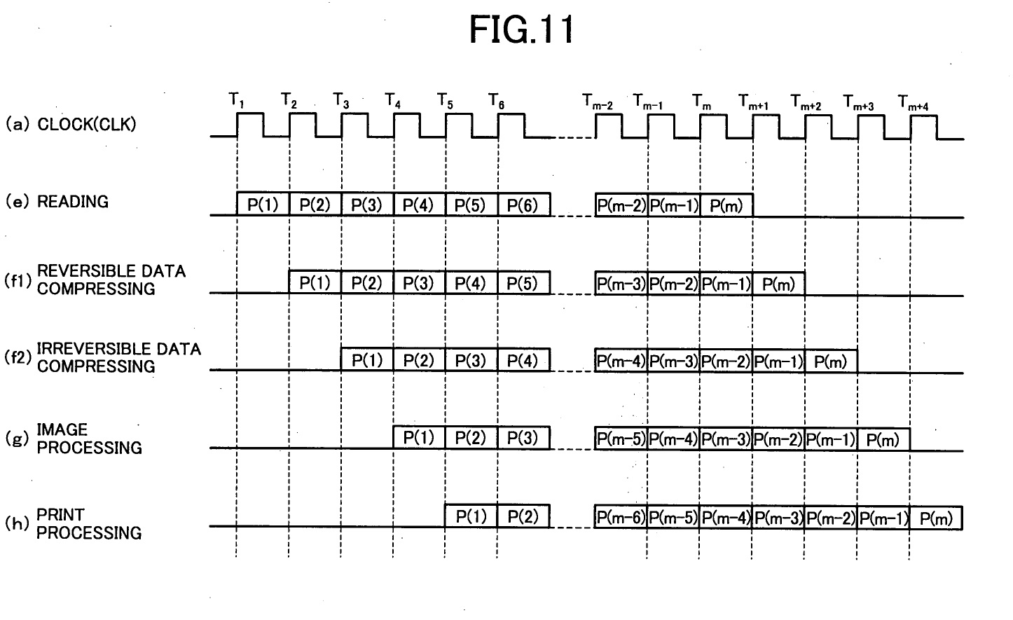

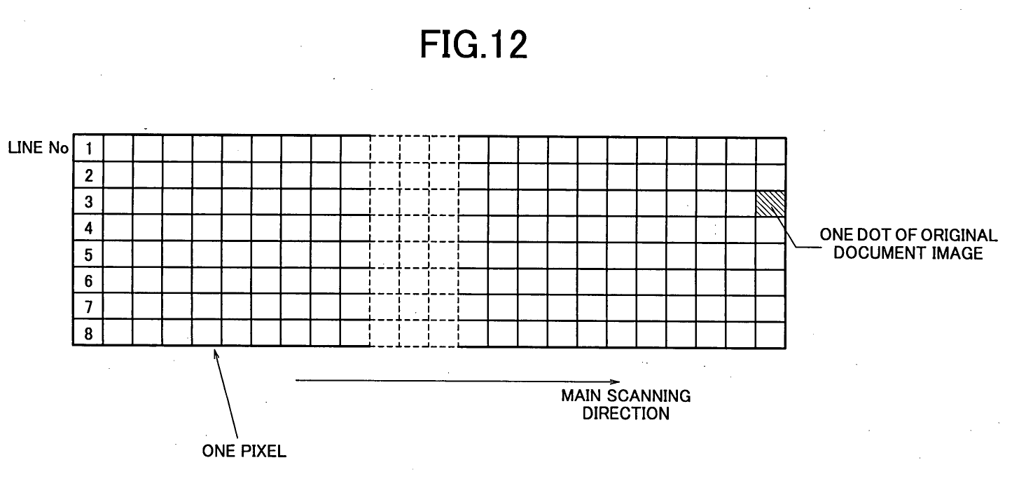

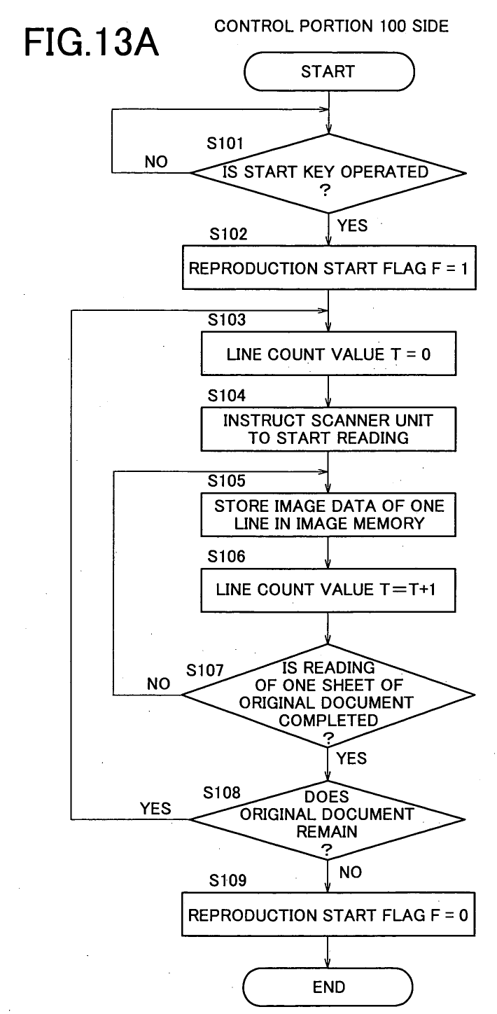

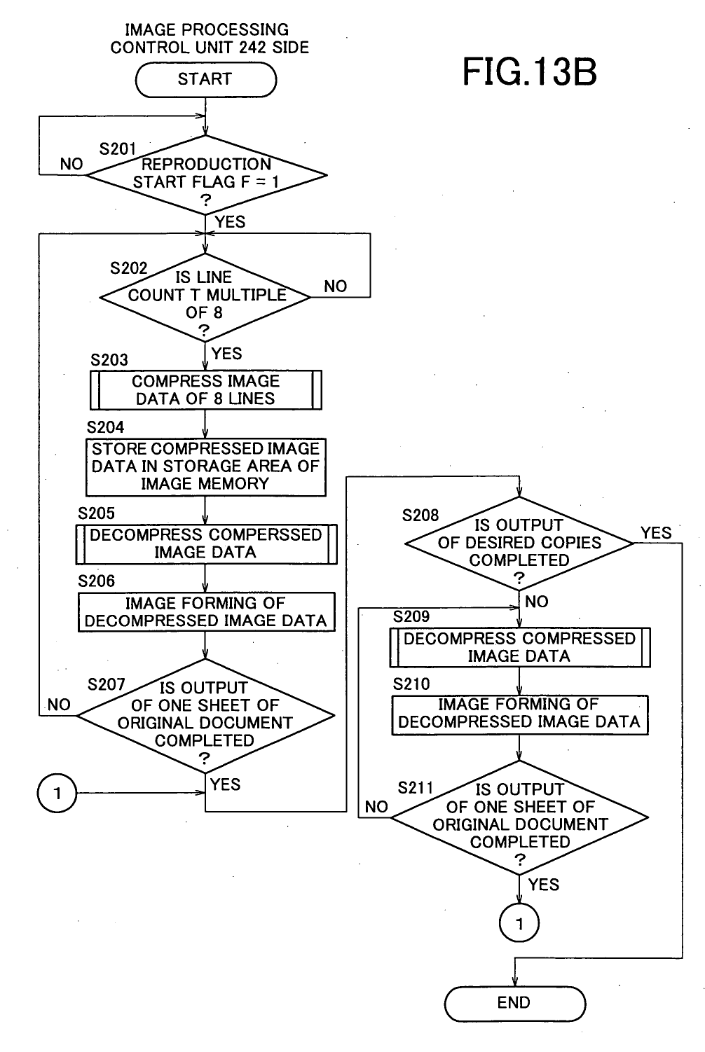

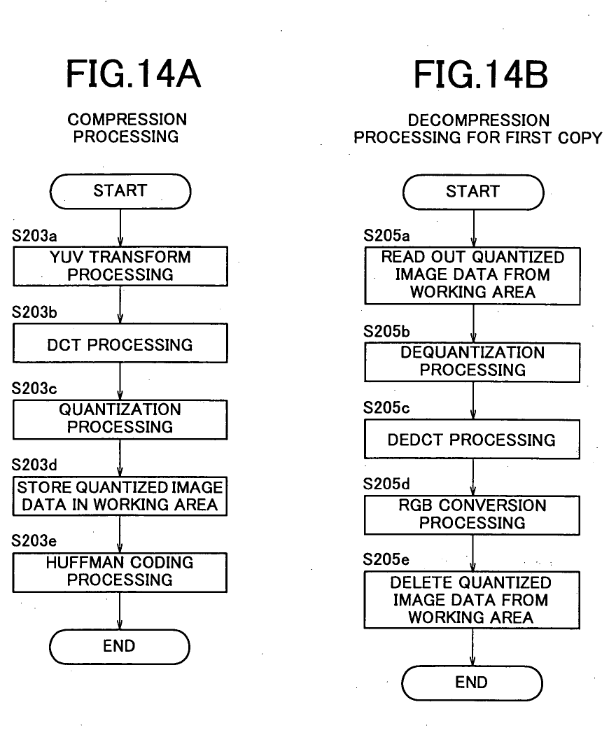

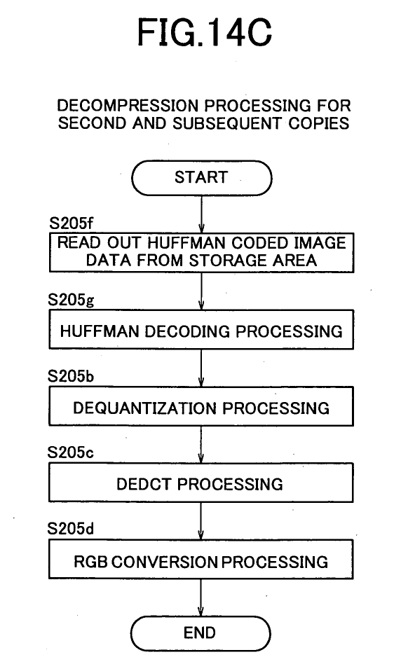

FIG. 2 is a front view showing the schematic structure of the image forming apparatus 10 of an embodiment of the present invention. FIG. 3 is a block diagram showing the schematic structure of a control system of the image forming apparatus. FIG. 4 is a block diagram showing the schematic structure of an image processing system of the image forming apparatus. FIG. 5 is a timing chart explaining an example of a process for reproducing a first copy using a memory copy function, which is conducted by the control system and the image processing system of the image forming apparatus. FIG. 6 is a timing chart explaining an example of a process for reproducing second and subsequent copies using a memory copy function, which is conducted by the control system and the image processing system of the image forming apparatus. FIG. 7 is a block diagram showing the schematic structure of an image processing system of the image forming apparatus of an example 1 of the present invention. FIG. 8 is a timing chart explaining an example of a process for reproducing a first copy using a memory copy function, which is conducted by the control system and the image processing system of the image forming apparatus. FIG. 9 is a block diagram showing an example of the schematic structure of an image processing system of the image forming apparatus of an example 2 of the present invention. FIG. 10 is a timing chart explaining an example of a process for reproducing a first copy using a memory copy function, which is conducted by the control system and the image processing system of the image forming apparatus. FIG. 11 is a timing chart explaining an example of a process for reproducing second and subsequent copies using a memory copy function, which is conducted by the control system and the image processing system of the image forming apparatus. FIG. 12 is a view explaining one unit of read image data. FIG. 13A is a flow chart explaining an example of the reproducing process using the memory copy function which is conducted by the control portion 100 of the image forming apparatus of an example 3 of the present invention. FIG. 13B is a flow chart explaining an example of the reproducing process using the memory copy function which is conducted by the image processing control unit 242 of the image forming apparatus of the example 3. FIG. 14A is a flow chart explaining one example of the compression processing. FIG. 14B is a flow chart explaining one example of the decompression processing for first copy. FIG. 14C is a flow chart explaining one example of the decompression processing for second and subsequent copies.

The schematic structure of whole of an image forming apparatus of one embodiment of the present invention and its control system will now be described with reference to the front view of FIG. 2 and the block diagram of FIG. 3.

As shown in FIGS. 2 and 3, the image forming apparatus 10 comprises a printer unit 12, a relay conveying unit 18 which is connected to the upper side of the printer unit 12, a scanner unit 13 and an automatic original document conveying unit 14, a sheet paper supply unit 16 which is connected to the lower side of the printer unit 12, a reverse conveying unit 11 which is connected to one side of the printer unit 12 and a sheet paper post-treating unit 15 which is disposed on the other side of the printer unit 12.

An operation and display portion 19 is provided on the top of the scanner unit 13 (refer to FIG. 3). The scanner unit 13 and the automatic original document conveying unit 14 which is disposed on the upper side of the scanner unit 13 are supported by a system rack 17, so that they are disposed above the printer unit 12 and sheet paper post-treating unit 15.

As shown in FIG. 3, the image forming apparatus 10 comprises a control portion 100 which is a main control portion of the image forming apparatus 10. The control portion 100 is connected to each component unit such as a system memory 101 and the operation and display portion 19 through system bus 103. The control portion 100 is adapted to control each unit of the apparatus in accordance with control programs stored in the system memory 101 and to temporarily store given data to be controlled, and data input from the operation and display portion 19 (for example, printing condition data such as the number of copies) in the system memory 101, for executing various processings.

The operation and display portion 19 is composed of, for example, a touch panel. The operation and display portion 19 is embodied by a display panel which is controlled by the control portion 100 to display the operation states of the apparatus and information on input instructions to a user, ten keys which are actuated by the user when he or she inputs figures while watching the display panel and a start key which is actuated to cause the image forming apparatus 10 to initiate sheet paper conveying and processing for image forming. The display panel is also provided with various function keys which are embodied with appropriate timings.

As shown in FIG. 2, the scanner unit 13 exposes and scans an original document placed on a light-transparent platen 30 in one-line by one-line of a main scanning direction (normal to the moving direction of the scanning unit 31) of the original document data and sequentially in a subsidiary scanning direction (moving direction of the scanning unit 31) by means of the scanning unit 31 which moves along and below the platen 30 at a given speed, so that light reflected on and from the original document is guided toward a photo-electric converting element 34 through optical components such as a plurality of reflectors 32 and imaging lenses 33 for imaging thereon. In such a manner, the scanner unit 13 reads the images of the original document on a one-line by one-line basis with a given resolution and converts the read images of the original document into image data of RGB format, which is a electrical signal, for sequentially inputting the image data into the printer unit 12 on a one-line by one-line basis.

The automatic original document conveying unit 14 is disposed so that it covers the original document platen 30 and comprises an original document conveying portion 41 which conveys the original document which was placed on a original document placing tray 40 by the user to and on the original document platen 30 and discharges the scanned original document to original document discharge tray 42. The automatic original document conveying unit 14 is configured so that the unit 14 can be pivoted upward around a pivotal point in the inside of the apparatus to expose the original document platen 30 on which the user is able to manually place an original document. Thus, the image forming apparatus 10 has automatic original document image reading capability in which each of original documents in the form of sheet is automatically conveyed to the scanner unit 13 by means of the automatic original document conveying unit 14 and is placed on the original document platen 30 where exposure and scanning of the original document is sequentially conducted and a manual reading capability in which the images of the original document which is manually placed on the original document platen 30 by the user are read.

The automatic original document conveying unit 14 is also provided with a sheet paper detecting sensor 300 which detects the end of the original document which is conveyed to the scanner unit 13 and a sheet paper detecting sensor 301 which detects the presence of the original document placed on the original document placing tray 40. Both sensors 300 and 301 may be composed of, for example, optical sensors and the like.

The printer unit 12 comprises a printing device 20 having a photoconductive drum 200 and a transfer device 203, which is disposed in a substantially center position of the printer unit 12, and a sheet paper supply portion 21 which is disposed in the lower part of the printer unit 12. The sheet paper supply portion 21 has a sheet paper accommodating tray which accommodates one or a plurality of sheets of paper and a sheet paper feeding portion 211 which supplies the sheets of paper which are accommodated in the sheet paper accommodating tray 210 to the printing device 20 on a one-sheet by one-sheet basis. The sheet paper supply portion 21 is removably provided with the sheet paper accommodating tray 210, so that the tray 210 is removed from the apparatus to allow the user to replenishing the addition sheets of paper. For example, plain paper sheets which are printable on both sides thereof and the both sides of which have identical attributes are accommodated in the sheet paper accommodating tray 210. The printer unit 12 is provided with a sheet paper entry inlet 27 which accepts the sheets of paper supplied from the sheet supply unit 16.

The sheet supply unit 16 comprises three sheet supply portions 61, 62, 63 which have sheet paper accommodating trays 610, 620, 630 which accommodate one or a plurality of sheets of paper and feeding portions 611, 621, 631 which feed sheets of paper accommodated in the sheet paper accommodating trays 610, 620, 630 to the printing device 20 from the sheet paper entry inlet 27 on a one-sheet by one-sheet basis, respectively. The sheet paper accommodating trays 610, 620, 630 are removable from the sheet paper supply unit 16 so that the user is able to replenish the sheets of paper thereto. For example, sheets of special paper, the both sides of which are printable, which has letterheading on the face side thereof are accommodated in the sheet paper accommodating tray 610 with its face surface facing upward. For example, sheets of plain paper having a size larger than that accommodated in the sheet paper accommodating tray 210 are accommodated in the sheet paper accommodating tray 620. For example, sheets of special paper, the both sides of which are printable having punched holes on the left side as viewed at the face surface thereof are accommodated in the sheet accommodating tray 630 with its face surface facing upward.

The printer unit 12 comprises a photo-scanning portion 22 which is in the vicinity of the printing device 20. An image processing control unit 242 comprising a process control unit (PCU) board for controlling the image forming processing is provided above the photo-scanning portion 22. When the image data of RG13 format which is read by the scanner unit 13 and converted under control of the control portion 100 (refer to FIG. 3) is input to the printer unit 12 on a one-line by one-line basis, the input image data is temporarily stored until the image data of N lines is accumulated in a buffer (not shown) by the image processing control unit 242. The image processing control unit 242 conducts various control processings including transfer of the image data of N lines among the image processing portion 25, printing device 20 and a compressing and decompressing portion 260. The image processing portion 25 comprises an image control unit (ICU) board which conducts a predetermined processing for the image data output from the compressing and decompressing portion 260 and scans and records the processed image data on the photoconductive drum 200 as electrostatic latent images by the photo scanning portion 22.

The present embodiment will be described by way of an example in which the image data of N lines (corresponding to the image data of a given portion less than a full page of an original document) is treated as one unit and sequentially transferred to the compressing and decompressing portion 260 by the image processing control unit 242 as described above. Specifically, 8 lines will be treated as one unit of image as shown in FIG. 12. “One line” used herein refers to the image of one line of an original document in a main scanning direction (refer to FIG. 12).

A supply and conveying control portion 102 (refer to FIG. 3) is controlled by the control portion 100 to conduct rotation drive or switching of supply means (feeding portions 211, 611, 621, 631), conveying means and reversing means (transporting rollers 110, 57 and conveying output rollers 28, 83 and the like which will be described below), and the destination of transportation switching means (gates 251, 81 and the like which will be described below).

A sheet of paper is supplied to the printing device 20 by means of the feeding portions 211, 611, 621, 631 which are controlled by the supply and conveying control portion 102. On forming images on the sheet of paper, the photoconductive drum 200 and transfer device 203 are controlled to be driven to rotate by the supply and conveying control portion 102 and images are formed on the sheet of paper which is supplied between the photoconductive drum 200 and the transfer device 203 and conveyed to the upper portion of the printing device 20. In this case, electrostatic latent images corresponding to the image data are formed on the outer circumferential periphery of the photoconductive drum 200 by the photo scanning portion 22 which is controlled by the image processing control unit 242. The electrostatic latent images are developed with toners so that toner images are formed. The toner images are transferred from the drum 200 to the sheet of paper which is supplied between the photoconductive drum 200 and the transfer device 203. In other words, the images are formed on the side of the sheet of paper which is in contact with the photoconductive drum 200.

A fixing portion 23 is provided above the printing device 20. The fixing portion 23 is driven to rotate under control of the supply and conveying control portion 102, so that it consecutively accepts the sheets of paper conveyed from the printing device 20 for heating the developing agent transferred on the sheet of paper. After the toner images are fixed on the sheet of paper by this heating, the sheet of paper is conveyed to a position above the fixing portion 23. When no images are formed on the sheet of paper if the sheet is supplied to the printing device 20 by the feeding portions 211, 611, 621, 631 which are controlled by the supply and conveying control portion 102 an idling conveying is conducted. In this case, the photoconductive drum 200 and the transfer device 203 are driven to rotate under control of the supply and conveying control portion 102 for conveying the sheet of paper supplied between the photoconductive drum 200 and the transfer device 203 to the top of the printing device 20. The fixing portion 23 is driven to rotate under control of the supply and conveying control portion 102 for consecutively accepting the sheets of paper conveyed from the printing device 20 (sheets of paper having no images thereon) to convey them to the upper portion of the fixing portion 23.

A gate 251 is disposed above the fixing portion 23. When a sheet of paper is conveyed from the fixing portion 23 to the gate 251, the gate 251 is switched under control of the supply and conveying control portion 102 so that the sheet of paper is conveyed to the relay conveying unit 18 from the printer unit 12. Thus, the sheet of paper which is conveyed above the fixing portion 23 is brought into contact with the gate 251 and then is guided to the conveying out rollers 28 for conveying it to the relay conveying unit 18.

The conveying out roller 28 is provided between the printer unit 12 and the relay conveying unit 18. The conveying out roller 28 can be rotated in normal and reverse directions under control of the supply and conveying control portion 102. When it is rotated in a normal direction, it conveys the sheet of paper from the printer unit 12 to the relay conveying unit 18. When it is rotated in a reverse direction, it conveys the sheet of paper from the relay conveying unit 18 to the printer unit 12. When the sheet of paper is reversed, the supply and conveying control portion 102 causes the conveying out roller 28 to be rotated in a normal or reverse direction. When the sheet of paper is not reversed, it causes the roller 28 to rotate only in a normal direction.

When the sheet of paper is conveyed to the printer unit 12 from the relay conveying unit 18 by means of the conveying out roller 28, the gate 251 is switched so that the sheet of paper is conveyed to the reverse conveying unit 11. Accordingly, the sheet of paper is passed through the gate 251 and is guided to the conveying roller 110 for conveying the sheet of paper to the reverse conveying unit 11.

The relay conveying unit 18 comprises a gate 81 which is adjacent to the conveying out roller 28. When the sheet of paper is not reversed if it is conveyed from the printer unit 12 to the relay conveying unit 18, the gate 81 is switched under control of the supply and conveying control portion 102 so that the sheet of paper is conveyed to the sheet post-treating unit 15. Accordingly, the sheet of paper which is conveyed to the relay conveying unit 18 is passed through the gate 81 and is guided to the lower part of the relay conveying unit 18 and is subsequently guided to a conveying roller 110 for conveying it to the sheet post-treating unit 15.

The relay conveying unit 18 comprises the conveying out rollers 83 which are disposed in upper portion of the relay conveying unit 18 and a reversing tray 82 which is disposed on the upper face of the relay conveying unit 18. When a sheet of paper is reversed if the sheet of paper is conveyed from the printer unit 12 to the relay conveying unit 18, the gate 81 is switched so that the sheet of paper is conveyed from the inside of the relay conveying unit 18 to the reversing tray 82. Accordingly, the sheet of paper which is conveyed to the relay conveying unit 18 is brought into contact with the gate 81 and is then guided to the conveying out roller 83 for conveying out the sheet of paper to the reversing tray 82.

The conveying out roller 83 is capable of rotating in normal and reverse directions under control of the supply and conveying control portion 102. When the conveying out roller 83 is rotated in a normal direction, it conveys the sheet of paper through the inside of the relay conveying unit 18 (gate 81) from the conveying out roller 28 to the reversing tray 82. When the conveying out roller 83 is rotated in a reverse direction, it conveys the sheet of paper through the gate 81 from the reversing tray 82 to the conveying out roller 28. When the sheet of paper is reversed, the supply and conveying control portion 102 causes the conveying out roller 83 to be rotated in a normal direction for conveying out the sheet of paper to the reversing tray 82 once and then causes the conveying out roller 83 to be rotated in a reverse direction for conveying the sheet of paper on the reversing tray 82 to the inside of the relay conveying unit 18.

The reverse conveying unit 11 comprises a conveying roller 110 therein. The sheet of paper, which is conveyed through the gate 251 to the reverse conveying unit 11 by means of reversely rotating conveying out roller 28, is passed through the inside of the reverse conveying unit 11 and is conveyed to the printer unit 12 and then to the printing device 20 by means of the conveying roller 110.

The supply and conveying control portion 102 counts the number of reversing of the sheets of paper (in this case the number of detected sheets) and causes the system memory 101 to store the count if the sheets of paper are reversed (for example, in case that sheet detecting means for detecting the sheets of paper which is provided on the reverse conveying unit 11 detect the sheets of paper).

The sheet post-treating unit 15 has a capability of post-treating (for example, stapling) the sheets. The sheet post-treating unit 15 comprises conveying rollers 50 between the sheet post-treating unit 15 and the relay conveying unit 18. The conveying rollers 50 convey the sheets of paper from the relay conveying unit 18 to the inside of the sheet post-treating unit 15 under control of the supply and conveying control portion 102.

The sheet post-treating unit 15 comprises a gate 52. The supply and conveying control portion 102 switches the gate 52 in accordance with conditions which are input by the user using the operation and display portion 19. If, for example, stapling treatment is conducted for the sheets of paper, the gate 52 is switched so that the sheets of paper which are conveyed to the inside of the sheet post-treating unit 15 will be conveyed to the conveying roller 57. If no stapling treatment is conducted, the gate 52 is switched so that the sheets of paper will be conveyed to discharging rollers 53.

The sheet paper post-treating unit 15 comprises sheet discharging trays 56, 59 for discharging the sheets of paper on which images are formed, which project beyond the present apparatus. The sheet post-treating unit 15 further comprises discharging rollers 53 for discharging the sheets of paper to the sheet discharging tray 56. The sheet of paper which is conveyed to the discharging rollers 53 is discharged to the sheet discharging tray 56 by means of the discharging rollers 53. The sheet of paper which is conveyed to the conveying rollers 57 is discharged to the sheet discharging tray 59 after it is subjected to stapling treatment by the stapling treatment portion 58.

The staple treating portion 58 comprises a staple tray, aligning plates for aligning the sheets of paper in a direction which is normal to the conveying direction, roller and belt pair conveying means for conveying the sheets of paper on the staple tray, an abutting guide for aligning the edges of the sheets of paper on the staple tray, a stapler for staple treatment, and a discharge guide for staple treated sheets of paper to discharging rollers. The sheets of paper, which are stapled are discharged to the sheet discharging tray 59 by the discharging rollers. The sheet of paper which is guided to the staple tray of the staple treating portion 58 is brought into contact at its end in the conveying direction with the roller and belt pair conveying means and abut on the abutting guide by the roller and belt conveying means. The sheet of paper is aligned at the edges in the direction which is normal to the conveying direction is aligned by the aligning plates. When a given number of sheets of paper are stacked on the staple tray, they are subjected to a staple treatment.

Now, schematic structure of an image processing system of the image forming apparatus 10 of the embodiment of the present invention will be described with reference to block diagram of FIG. 4.

As shown in FIG. 4, the image processing system of the image forming apparatus 10 of the embodiment of the present invention comprises the above-mentioned scanner unit 13, image processing portion 25, printing device 20 and a compressing and decompressing portion 260 which will be described below.

The compressing and decompressing portion 260 comprises, as shown in the figure, a compressing circuit 265 (an example of image data compressing portion), decompressing circuit 266 (an example of image data decompressing portion), image memory 262 (an example of storage portion) and an HDD 263 (another example of storage portion). These components are communicatively connected to each other via data buses and the like. Communication of data among these components is controlled by the image processing control unit 242 including a bus controller and the like.

Both of the compressing circuit 265 and decompressing circuit 266 are integrated circuits such as LSI or VLSI. The compressing circuit 265 sequentially applies at least irreversible compression processing to image data of 8 lines which are sequentially input into the compressing circuit 265 by the image processing control unit 242. Specifically, the compressing circuit 265 may be a circuit which conducts compression processing of images of JPEG format. On the other hand, the decompressing circuit 266 sequentially decompresses compressed image data (hereinafter referred to as “irreversible compressed image data”) of 8 lines which were transferred from the compressing circuit 265 by the image processing control unit 242 in an transfer order. Since the compressing circuit 265 sequentially applies the irreversible compression processing, the image data which is decompressed by the decompressing circuit 266 is not precisely recovered to the original image data prior to compression.

The image memory 262 is a semiconductor memory such as RAM (Random Access Memory) for storing image data. The memory area of the image memory 262 is appropriately divided into a working area at which compression and decompression is executed by the compressing and decompressing circuits 265 and 266, respectively, and a storage area at which the irreversible compressed image data after compression is temporarily stored. If the compressing and decompressing circuits 265 and 266 per se include an internal memory having a working area at which compression and decompression is executed, it is of course the whole memory area of the image memory 262 is used for temporal storage of the irreversible compressed image data.

The HDD 263 covers the storage area of the image memory 262. The data which is overflowed from the storage area of the image memory 262 is stored in the storage area of the HDD 263. Although the image processing system may be configured so that the HDD 263 directly stores the irreversible compressed image data without using the image memory 262, use of the image memory 262 is more preferable in view of speed of storage and processing of the data.

Since the image processing system of the image forming apparatus 10 is configured in such a manner, if a plurality of copies of a plurality pages of the original documents are printed, reading of first page of the original document is initiated by the scanner unit 13 and the image data of one line which is sequentially read from the beginning of the first page on one-line by one-line basis by the scanner unit 13 is sequentially input to the printer unit 12. In the printer unit 12, the sequentially input image data of one line is accumulated to form the image data of 8 lines by the image processing control unit 242. The image data of 8 lines is then transferred to the compressing circuit 265 of the compressing and decompressing portion 260.

In the compressing circuit 265, irreversible compression processing is sequentially conducted for the image data of 8 lines. Subsequently, the compressed irreversible compressed image data is sequentially stored in the image memory 262. The irreversible compressed image data which is sequentially stored in the image memory 262 is sequentially transferred to the decompressing circuit 266 by the image processing control unit 242. After the transferred image data is decompressed to the original image data of 8 lines (however, which is not completely restored image data) in the decompressing circuit 266, it is transferred to the image processing portion 25. In the image processing portion 25, the decompressed image data of 8 lines is converted into print data of YMCK format which is printable by the printing device 20 and is transferred to the printing device 20.

Compression, storage, decompression and transfer of the image data is conducted in synchronization with a clock signal (CLK) output to various portions from a clock generator 35 of FIG. 4. Compression, storage and decompression of image data of 8 lines which is less than one page of the original document is sequentially conducted. Since image processing is initiated prior to completion of reading of a full first page of the original document, first copy time can be effectively shortened. Since the image data of a first copy is subjected to compression and decompression processing unlike the above-mentioned prior art (refer to Japanese Laid-Open Patent Publication No. 9-224106), no difference in image quality between the first copy and second and subsequent copies will occur.

An exemplary process of first and second reproduction (copying) using memory copy function which is conducted by the control system and image processing system of the image forming apparatus 10 will be described with reference to timing charts of FIGS. 5 and 6 together with FIGS. 3 and 4.

As mentioned above, the scanner unit 13, compressing and decompressing portion 260, image processing portion 25 and printing device 20 are operated in synchronization with a clock generated by the clock generator 35. The frequency of the clock (that is, clock frequency) is preliminarily set depending upon time taken for various processes such as compression, storage, decompression and image processing and print of each image unit, one unit of 8 lines, which is read by the scanner unit 13 and reading speed and time of the scanner unit 13, which is necessary to read the image data of 8 lines.

Now, reproduction processing of the first copy will be described with reference to FIG. 5. When the user depresses a start key on the operation and display portion 19, the scanner unit 13 is actuated by the control portion 100 so that an original document which is automatically or manually placed upon the platen 30 is subjected to exposure and scanning. At time T1 in FIG. 5, the image of the first copy of an original document at a first page is read on a one-line-by-one-line basis. At time T2 when the reading is completed, the read image data is transferred to the compressing circuit 265 of the compressing and decompressing portion 260 by the control portion 100 (FIG. 3) and the image processing control unit 242 (FIG. 3). In that processing, image data P(1) of 8 lines is treated as one unit.

The transferred image data P(1) is compressed from the time T2 in the compressing circuit 265 and thereafter the compressed image data P(1) is transferred to an image memory 262 by the image processing control unit 242 at time T3 and the compressed image data P(1) is stored in the image memory 262. The image processing control unit 242 which conducts such image storage processing corresponds to image data storing portion.

Immediately after storage of the image data in the image memory 262, the stored compressed image data P(1) is read by the image processing control unit 242 at time T4 and is transferred to the decompressing circuit 266. The compressed image data P(1) which is transferred to the decompressing circuit 266 is subsequently decompressed by the decompressing circuit 266 at time T5. The decompressed image data P(1) is transferred to the image processing portion 25 at time T6. After the image data P(1) is subjected to a predetermined transform processing, it is transferred to printing device 20 at time T7. Processing for forming images on a sheet of paper is conducted based upon the decompressed image data P(1) in the printing device 20.

Such a series of processings is sequentially conducted for the image data P(2) which is read by the scanner unit 13 at time T2 in FIG. 5, image data P(3), P(4), . . . which is read at times T3, T4, . . . , that is, such a series of processings is sequentially and repeatedly conducted from the image data P(1) of first page of the first original document to the final image data P(m) thereof. Therefore, for example, compression processing of the image data P(5) by the compressing circuit 265, storage processing (storing processing) of the image data P(4) by the image processing control unit 242 and decompression processing of the image data P(2) by the decompressing circuit 266 are conducted in parallel. In other words, the compressing circuit 265, image processing control unit 242 and the decompressing circuit 266 are operated in parallel. If the original documents have a plurality of pages, a series of the above-mentioned processings is conducted for all pages.

The image forming of the first sheet of the original document is conducted through such a series of processings. Since processing of compression, storage, decompression and image forming is conducted each time when a given portion (corresponding to 8 lines herein) less than full page of one sheet of the original document is read unlike the prior art in which processing of compression, storage, decompression and image forming is conducted after reading of a full page of a sheet of original document is completed, the above-mentioned first copy time can be shortened.

Subsequently, a case in which reproduction of second copy is conducted will be described with reference to FIG. 6. Firstly, the compressed image data P(1) which is stored in the image memory 262 is read out by the image processing control unit 242 at time T1 in FIG. 6 and is then transferred to the decompressing circuit 266. The compressed image data P(1) which is transferred to the decompressing circuit 266 is then decompressed by the decompressing circuit 266 at time T2. The decompressed image data P(1) is transferred to the image processing portion 25 at time T3. After the image data is subjected to a predetermined conversion processing, it is transferred to the printing device 20 at time T4.

Such a series of processings is also sequentially conducted for the image data P(2) which is read out from the image memory 262 at time T2 in FIG. 6, the image data P(3), P(4), . . . , which is read at times T3, T4, . . . , that is, such a series of processings is sequentially and repeatedly conducted from the image data P(1) of first page of the second original document to the final image data P(m) thereof. Such a series of processings is also conducted for the third and subsequent copies.

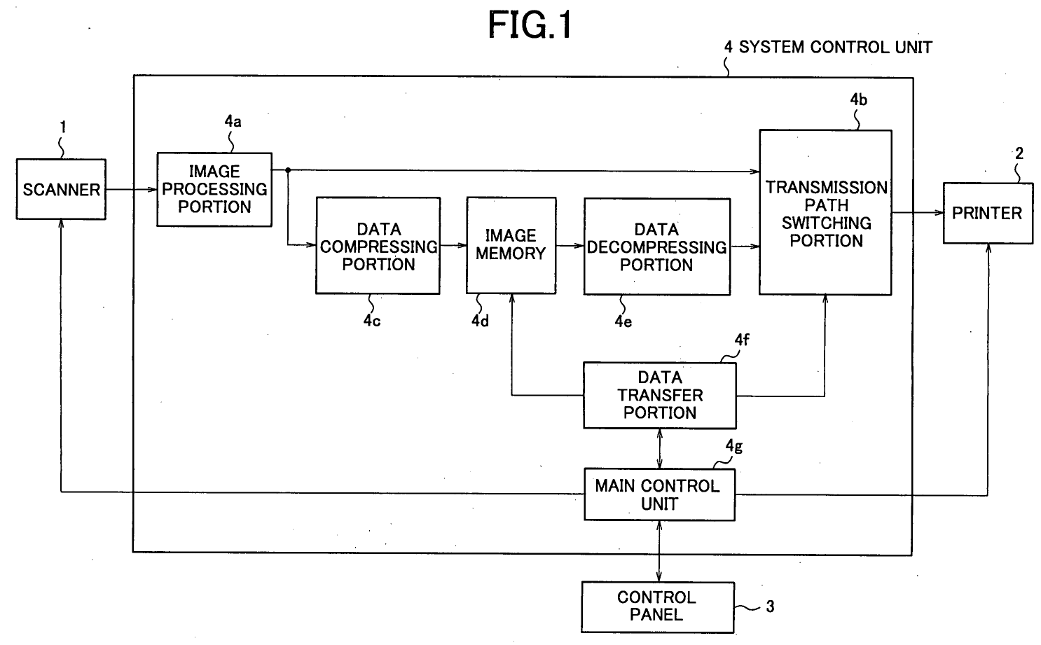

Since reading operation by the scanner unit 13 is not necessary for the image formation of the second and subsequent reproductions, one-time reading of the original document allows a plurality of reproductions of the original document to be accomplished. In this case, since image forming for first and second copies is conducted based upon the image data (decompressed image data) which is decompressed after it is subjected to irreversible compression processing once, the second copy has the same image quality as that of the first copy although the image data is subjected to the irreversible compression processing of a high compression rate unlike the prior art (refer to, for example, Japanese Laid-Open Patent Publication No. 9-224106) shown in FIG. 1.

### EXAMPLE 1

Subsequently, an example 1 of the present invention will be described with reference to FIGS. 7 and 8. FIG. 7 is a block diagram showing the schematic structure of the image processing system of the image forming apparatus of the example 1 of the present invention. FIG. 8 is a timing chart explaining an exemplary reproduction process of a first copy using the memory copy function which is executed by the control system and image processing system of the image forming apparatus. The components which are identical with those of the image processing system of the image forming apparatus 10 according to the embodiment of the present invention are denoted by identical reference numerals and detailed description of the identical components will be omitted.

As shown in FIG. 7, the image processing system of the image forming apparatus of the example 1 of the present invention comprises a scanner unit 13, compressing and decompressing portion 260a, image processing portion 25 and printing device 20. The compressing and decompressing portion 260a is substantially identical in configuration with the compressing and decompressing portion 260 of the image forming apparatus 10 of the embodiment of the present invention except that storing processing by the image processing control unit 242 which performs as the image data storing portion is conducted in parallel with decompression processing by the decompressing circuit 266 for the irreversible compressed image data by the compressing circuit 265. The parallel operation of the storing processing and the decompression processing is accomplished by the fact that the image processing control unit 242 transfers irreversible compressed data which is compressed by the compressing circuit 265 to the image memory 262 and also to the decompressing circuit 266. The image processing control unit 242 which conducts such a transfer operation corresponds to the storing and decompression processing portion.

An exemplary process for reproducing a first copy using the memory copy function, which is executed by the control system and image processing system of the image forming apparatus, will be described with reference to the timing chart of FIG. 8 together with FIGS. 3 and 7.

The image data P(1) of 8 lines which was read at time T1 in FIG. 8, as is similarly to the above-mentioned embodiment, is subsequently transferred to the compressing circuit 265 by the control portion 100 and image processing control unit 242 at time T2 and the image data P(1) is compressed in the compressing circuit 265.

Subsequently, the compressed image data P(1) is transferred to the image memory 262 by the image processing control unit 242 at time T3 in FIG. 8 and is stored in the image memory 262. In parallel with this storing processing, the image processing control unit 242 transfers the compressed image data P(1) to the decompressing circuit 266 at time T3 for decompressing the compressed image data P(1) therein.

The image data P(1) which is decompressed in the decompressing circuit 266 is then transferred to the image processing portion 25 at time T4. After being subjected to a given conversion processing, the image data P(1) is transferred to the printing device 20 at time T5. Then, a processing for forming images on a sheet of paper is executed based upon the decompressed image data P(1) in the printing device 20.

Since the reproducing process for the second copy is conducted similarly to that of the above-mentioned embodiment, description thereof will be omitted.

As shown in FIG. 7, if an external device such as facsimile device 36 shares a storage device such as the image memory 262, for example, the image data transfer between the compressing circuit 265 and the image memory 262 and between the decompressing circuit 266 and the image memory 262 is congested while the facsimile device 36 makes access to the image memory 262. As a result, the first copy time until the start of printing in the printing device 20 may be extended. In the example 1, due to the fact that a series of the above-mentioned processings is conducted, transfer of the image data from the image memory 262 to the decompressing circuit 266 is not performed, and storing processing of the compressed image data in the image memory 262 is conducted in parallel with the decompression processing in the decompressing circuit 266 in reproducing the first copy. Accordingly, the processing speed is improved and further shortening of the first copy time can be achieved. Thus, no problem occurs.

### EXAMPLE 2

An example 2 of the present invention will be described with reference to FIGS. 9 through 11. FIG. 9 is a block diagram showing an example of the schematic structure of the image processing system of the image forming apparatus of the example 2 of the present invention; FIG. 10 is a timing chart explaining an exemplary reproduction process of a first copy using a memory copy function which is performed by the control system and image processing system of the image forming apparatus; and FIG. 11 is a timing chart explaining an exemplary reproduction processing of a second and subsequent copies using a memory copy function which is performed by the control system and image processing system of the image forming apparatus.

A case in which an image compression processing in JPEG format which is a representative compression and decompression format of irreversible compression and decompression processing is used as irreversible compression executed in the above-mentioned compressing circuit 265 will be considered. The compression processing in the JPEG format comprises four processing steps, such as a YUV transform processing for converting RGB image data which is fed from the scanner unit 13 into YUV image data, a discrete cosine transform (DCT) processing for transforming the YUV image data which is transformed by the YUV transform processing into frequency components; a quantization processing for quantizing the image data after the DCT processing; and a Huffman coding processing for compressing the data amount by changing code length depending on appearance rate of codes. Therefore, the compressing circuit 265 comprises a YUV transform circuit 265a which conducts the YUV transform, DCT circuit 265b which conducts the DCT processing, a quantization circuit 265c which conducts the quantization of the image data and a Huffman coding circuit 265d which conducts Huffman coding. The decompressing circuit 266 comprises a Huffman decoding circuit 266a which conducts Huffman decoding, a dequantization circuit 266b which conducts dequantization, deDCT circuit 266c which conducts deDCT and a RGB conversion circuit 266d for converting YUV image data into RGB image data.

Among each processing included in the data compressing processes in the JPEG format, both the DCT and quantization processings are irreversible compression processing which is not capable of restoring the processed data into original data whereas the Huffman coding processing is a reversible compression process. Accordingly, the compression processing of JPEG format irreversibly compresses the image data by irreversibly compressing the input image data once and thereafter reversibly compressing the irreversible compressed image data which is obtained by the irreversible compression.

A decompression processing which decompresses the compressed image data which is compressed by data compression processing in the JPEG format may be conducted in an order which is reverse to that of the compressing process. That is, the decompression processing may be executed in an order of Huffman decoding processing, dequantization processing, deDCT processing and RGB conversion processing.

In the example 2 of the present invention, the YUV transform, DCT and quantization is conducted for the image data which is transferred to the compressing circuit 265 in this order. Thereafter, Huffman coding processing which conducts the Huffman coding for the quantized image data in parallel with processing for decompressing the quantized image data (dequantization, deDCT and RGB conversion).

An exemplary process for reproducing a first copy using the memory copy function, which is performed by the control system and image processing system of the image forming apparatus, will be described with reference to the timing charts of FIGS. 10 and 11 together with FIGS. 3 and 9.

The image data P(1) of 8 lines which was read at time T1 in FIG. 10 as is similarly to the above-mentioned example 1 is subsequently transferred to the compressing circuit 265 by the control portion 100 and image processing control unit 242 at time T2.

The input image data P(1) of 8 lines is sequentially passed through the YUV transform circuit 265a, DCT circuit 265b and quantization circuit 265c of the compressing circuit 265 so that it is irreversibly compressed.

The irreversible compressed image data is thereafter transferred to the Huffman coding circuit 265d and (the dequantization circuit 266b) of the decompressing circuit 266, respectively, at time T3 and is subjected to Huffman coding in the Huffman coding circuit 265d and is subjected to dequantization processing in the dequantization circuit 266b and is subjected to deDCT processing in the deDCT circuit 266c and is subjected to RGB conversion processing in the RGB conversion circuit 266d in the decompressing circuit 266.

The image data P(1) which is subjected to Huffman coding at the time T3 so that it is completely JPEG compressed is then transferred to the image memory 262 and is stored in the image memory 262 under control of the image processing control unit 242 at time T4.

On the other hand, the image data P(1) which is decompressed by the parallel processing at time T3 by being passed through the dequantization circuit 266b, deDCT circuit 266c, an RGB conversion circuit 266d is thereafter transferred to the image processing portion 25 at time T4. After being subjected to a given transform, it is transferred to the printing device 20 at time T5. A processing for forming images on a sheet of paper is conducted based upon the decompressed image data P(1) in the printing device 20. Such a series of processings is sequentially repeated for the image data P(1) of the first copy of the first page of the original document to the final image data P(m) of the first copy of first page.

If a first copy of the original document is output in such a manner, the processing period of time which is taken for the Huffman decoding is shortened to achieve the shortening of the first copy time subjecting the read image data to only irreversible decompression processing (dequantization processing, deDCT processing and RGB conversion processing) for the image data which is subjected to irreversible compression processing (YUV transform, DCT processing and quantization processing). Since the Huffman decoding is omitted, the processing burden which is otherwise imposed is eliminated. Since the Huffman decoding processing is eliminated only when a first copy of the original document is output, speeding-up of the clock can be correspondingly achieved, result in a high speed processing.

Subsequently, reproduction of second copy of the original document will be described with reference to FIG. 11. The compressed image data P(1) which is stored in the image memory 262 is read at time T1 in FIG. 11 by the image processing control unit 242 and is then transferred to the decompressing circuit 266 at time T2. In the decompressing circuit 266, the compressed image data P(1) is Huffman-decoded by the Huffman decoding circuit 266a. Thereafter, the image data which is Huffman-decoded is transferred to the dequantization circuit 266b at time T3 and is decompressed to the image data which is the image data prior to compression by being passed through the dequantization circuit 266b, deDCT circuit 266c, and RGB conversion circuit 266d. The decompressed image data P(1) is then transferred to the image processing portion 25 at time T4, and is transferred to the printing device 20 at time T5 after it is subjected to a predetermined transformation. A processing for forming images on a sheet of paper is performed in the printing device 20 based upon the decompressed image data P(1). Such a series of processings is sequentially repeated for the image data P(1) of the first copy of the first page of the original document to the final image data P(m) of the first copy of the first page thereof.

### EXAMPLE 3

An image forming apparatus of the example 3 of the present invention will be described with reference to FIGS. 13A and 13B. Since the present image forming apparatus is substantially identical in structure with the image forming apparatus 10 of the embodiment of the present invention, the components which are identical with those of the image forming apparatus 10 are represented by identical reference numerals and description thereof will be omitted herein. The present image forming apparatus is different from the image forming apparatus 10 in the processing contents which is conducted by the control portion 100 and image processing control unit 242 in the reproducing processing. Now, this difference will be described in detail.

FIGS. 13A and 13B are flow charts showing an example of steps of a reproduction process using a memory copy function which is conducted by the control portion 100 and the image processing control unit 242 of the image forming apparatus of an example 3 of the present invention. Reference numerals in the figure S101, S102, . . . , S201, S202 denote processing steps which are conducted in the control portion 100 and image processing control unit 242, respectively.

A series of steps (steps S101 to S109) which is carried out in the reproduction process by the control portion 100 will be described with reference to FIG. 13A.

At step S101, a determination is made by the control portion 100 whether or not a start key of the operation and display portion 19 is operated by a user, that is whether or not start of reproduction is instructed. If it is determined that the start key of the operation and display portion 19 is operated (YES at step S101), a reproduction start flag F is set to “1” (step S102) and a line count value T which represents the number of read lines on the original document is initialized (T=0) (step S103). The reproduction start flag F is a flag provided in a flag register (not shown) in the system memory 101, and represents whether or not there is an instruction to start reproduction. The reproduction start flags F “1” and “0” denote that there is an instruction to start reproduction and there is no instruction to start reproduction or reproduction is completed, respectively. The line count value T is stored in the system memory 101 and is counted up by the transfer of each line of the image which is read by the scanner unit 13 in the processing at step S106, which will be described below, performed by the control portion 100. The reproduction start flag F and the line count value T can be referenced by the image processing control unit 242.

Subsequently at step S104, the scanner unit 13 is instructed to start reading of the image of the original document by the control portion 100. As mentioned above, in connection with the embodiment, this causes the scanner unit 13 to expose a first sheet of original document and scan it so that the images on the original document are read on a one line-by-one line basis. The image data of read each one line is transferred to the working area of the image memory 262 and stored therein by means of the control portion 100 (step S105). In association with this, the line count value T is counted up (T=T+1) by the control portion 100 (step S106). The processing at steps S105 and S106 is repeated until it is determined by the control portion 100 at step S107 that reading of the images on one sheet of original document is completed. A determination at step S107 is made by the control portion 100 based upon a result of detection made by the sheet paper detecting sensor 300.

On the other hand, if it is determined at step S107 that reading of the images on a sheet of the original document is completed, the processing will proceed to step S108 at which it is determined whether or not the document to be reproduced remains based upon a result of detection made by the sheet paper detecting sensor 301. If it is determined that the original document remains (YES at step S108), the processing will return to the step S103 and the steps which follow step S108 will be executed again. On the other hand, if it is determined that no original document remains (NO at step S108), the reproduction start flag F is reset (F=0) at step S109, thereafter processing performed by the control portion 100 is completed.

Subsequently, a series of processings (steps S201 to S208) which is executed by the image processing control unit 242 in parallel with a series of processings (steps S101 to S109) which is executed by the control portion 100 in the reproducing process will be described.

A process to execute first copy of the original document will be described with reference to FIG. 13B. At step S201, it is determined by the image processing control unit 242 whether or not the reproduction start flag F is set, that is start of reproducing is instructed or not. If it is determined that the reproduction start flag F is set (YES at step S201), the processing will proceed to step S202. The steps S202 to S206 are then sequentially executed by the image processing control unit 242.

It is determined at step S202 whether or not the line count value T which is counted by the control portion 100 is a multiple of 8. The determination at step S202 is repeated while it is determined that the line count value T is not a multiple of 8. If it is determined that the line count value T is a multiple of 8 (YES at step S202), the processing will proceed to step S203. If the line count value T is not a multiple of 8 although reading of the images on one sheet of the original document is completed, the image data of 8 lines is generated by adding additional image data corresponding to vacant lines to the image data less than 8 lines by the image processing control unit 242.

Compression of the image data of 8 lines which is stored in the working area of the image memory 262 (corresponding to image data compressing step) is conducted by the image processing control unit 242 at step S203. Specifically, the image data of 8 lines which is stored in the working area of the image memory 262 is read out by the image processing control unit 242 and is transferred to the compressing circuit 265, where compression of the image data is conducted by the compressing circuit 265. A term “compressing process” used herein refers to processings including at least irreversible compression process. The compression processing is conducted in the working area of the image memory 262 and the compressed image data is stored in the working area of the image memory 262.

The image data which is compressed by the compressing circuit 265 at step S203 is transferred from the working area to the storage area of the image memory 262 by the image processing control unit 242 for storage therein at step S204. This corresponds to image data storing step. Since the image data at the working area of the image memory 262 is deleted at this time, the working area is available for next compressing process.

Decompression of the image data which is compressed by the compressing circuit 265 is conducted by the image processing control unit 242 at step S205. This corresponds to image decompressing step. Specifically, the image data which is compressed by the compressing circuit 265 is read from the storage area of the image memory 262 by the image processing control unit 242 and is transferred to the decompressing circuit 266 at which a processing for decompressing the image data is conducted by the decompressing circuit 266. The decompression processing is conducted in the working area of the image memory 262. The decompressed image data is stored in the working area of the image memory 262.

A processing for forming images from the image data which is decompressed by the decompressing circuit 266 at step S205 is conducted at step S206. This processing corresponds to image forming step. Specifically, the image data which is decompressed by the decompressing circuit 266 at step S205 is transferred from the working area of the image memory 262 to the image processing portion 25 by the image processing control unit 242. Thus, the image data is subjected to a predetermined transform by the image processing portion 25. In the printing device 20, images are formed (printed) on a sheet of paper based upon the image data which is subjected to predetermined transform by the image processing portion 25.

Subsequently, the above-mentioned series of steps (steps S202 through S206) are repeated until it is determined at step S207 that output of the images on one sheet of the original document is completed. In other words, the steps are repeated for the first to final image data of the original document which are sequentially read by the scanner unit 13. A determination whether or not output of the images on one sheet of the original document is made by, for example, counting the number of lines of the output image. Specifically, a case in which reproduction of an original document of A4 size is conducted at 600 dpi is assumed. The original document has a shorter side of 210 mm in length, which is 210 mm/25.4 mm×600≈4960 lines. A determination that output of the images on one sheet of original document is completed may be made if the count value of the number of output lines reaches 4960.

If the original document has a plurality of pages, the above-mentioned series of steps (steps S202 through S207) are conducted for all pages. That is, a series of processings (steps S202 to S207) is conducted a number of times which is equal to the number of pages of the original document to the last page thereof.

The reproducing process of the first sheet of the original document is conducted through such a series of processings. Since processing of compression, storage, decompression and image forming is conducted each time when a given portion (corresponding to 8 lines herein) less than full page of one sheet of the original document is read unlike the prior art in which processing of compression, storage, decompression and image forming is conducted after reading of a full page of a sheet of original document is completed, the above-mentioned first copy time can be shortened.

Subsequently, a process for reproducing a second copy of the original document will be described with reference to FIG. 13B.

If it is determined at step S207 that output of the images on one sheet of the original document is completed, a determination is made at next step S208 whether or not the number of output copies reaches the number of copies which is preliminarily set by a user. If it is determined that the number of the output copies does not reach the preset number (NO at step S208), the processing will proceed to step S209. If it is determined that the number of the output copies reaches the preset number, processing by the image processing and control unit 242 is then completed.

Decompression of the image data which is compressed by the compressing circuit 265 is conducted by the image processing control unit 242 at step S209. This corresponds to the image data decompressing step. Specifically, the image data which is compressed by the compressing circuit 265 is read out from the storage area of the image memory 262 by the image processing control unit 242 and is transferred to the decompressing circuit 266 for decompressing the image data therein. The decompression processing is conducted in the working area of the image memory 262 and the decompressed image data is stored in the working area of the image memory 262.

A processing for forming images from the image data which is decompressed by the decompressing circuit 266 at the step S209 is conducted at step S210. This processing corresponds to image forming step. Specifically, the image data which is decompressed by the decompressing circuit 266 at the step S209 is transferred from the working area of the image memory 262 to the image processing portion 25 by the image processing control unit 242. Thus, the image data is subjected to a predetermined transform by the image processing portion 25. In the printing device 20, images are formed (printed) on a sheet of paper based upon the image data which is subjected to predetermined transform by the image processing portion 25.

Subsequently, the above-mentioned series of steps (steps S209 through S210) are repeated until it is determined at step S211 that output of the images on one sheet of the original document is completed. That is, the above series of steps are repeated for the first to final image data of the original document. Such a series of steps (steps S209 through S211) is similarly conducted for third and subsequent copies. When it is determined at step S208 that the output of the preset number of copies is completed, processing by the image processing control unit 242 is completed.

Since reading operation by the scanner unit 13 is not necessary for the image formation of the second and subsequent reproductions, only one reading of the original document allows a plurality of reproductions of the original document to be accomplished. In this case, since image forming for first and second and subsequent copies is conducted based upon the image data (decompressed image data) which is decompressed after it is subjected to irreversible compression processing once, the second and subsequent copies have the same image quality as that of the first copy although the image data is subjected to the irreversible compression processing of a high compression rate unlike the prior art (refer to, for example, Japanese Laid-Open Patent Publication No. 9-224106) shown in FIG. 1.

The image processing control unit 242, the compressing circuit 265 and decompressing circuit 266 may be integrated into DSP and the like. In this case, each processing such as the compression, storage, decompression of the image data and image formation is executed in the integrated circuit such as DSP by an arithmetic operation portion in accordance with a predetermined image forming program.

### EXAMPLE 4

A case in which the image compression processing in JPEG format which is a representative compressing and decompressing format of the irreversible compression and decompression processing is used as a compression processing which is conducted in compressing circuit 265 by controlling the compressing circuit 265 by means of the image processing control unit 242 in the image forming apparatus of the foregoing example 3 will be considered. Since the processing in the control portion 100 is identical with the processing which is described in the foregoing example 3 (refer to FIG. 13A), description thereof will be omitted. Since the processing in the image processing control unit 242 is substantially identical with the processing which is described in example 3 (refer to FIG. 13B) except that the processing contents in compression processing (step S203), and decompression processing (steps S205, S209) are different from those in example 3, description of the identical processing will be omitted.

As shown in flow chart of FIG. 14A, a YUV transform processing (step S203a) for converting the RGB image data which is fed from the scanner unit 13 into the YUV image data, a discrete cosine transform (DCT) processing (step S203b) for transforming the YUV image data which is converted by the YUV transform processing into frequency components, a quantization processing (step S203c) for quantizing the image data after the DCT processing, storage processing (step S203d) for temporarily storing the quantized image data in the working area of the image memory 262, and Huffman coding processing (step S203e) for compressing the quantity of the quantized image data by changing the code length depending upon the appearance rate of codes substantially in parallel with or after the storage processing are executed in the compression processing (step S203) in the image forming apparatus. As mentioned above, the DCT processing and quantization processing among each processing which are included in the data compression processing using JPEG format are irreversible compression processing which is not capable of restoring the processed data into original data while the Huffman coding processing is a reversible compression processing.

In the decompression processing of a first copy (step S205), the decompressing circuit 266 is controlled by the image processing control unit 242 as shown in FIG. 14B, so that the image data which is quantized in the quantization processing (step S203c) is read from the working area of the image memory 262 (step S205a) and dequantization processing (step S205b), deDCT processing (step S205c), RGB conversion processing (step S205d) are conducted for the image data. After a series of processings (steps S205a through S205d) is completed, the quantized image data which is stored in the storage processing (step S203d) is erased from the working area of the image memory 262 by the image processing control unit 242 (step S205e).

On the other hand, the image data which is subjected at the step S203 to compression processing including the Huffman coding processing (step S203e) is stored in the storage area of the image memory 262 at step S204 (refer to FIG. 13B) as mentioned above.

In the decompression processing (step S209) for reproducing second and subsequent copies as shown in FIG. 14c, the decompressing circuit 266 is controlled by the image processing control unit 242 so that the image data which is Huffman coded in the Huffman coding processing (step S203e) is read out from the storage area of the image memory 262 (step S205f) and the Huffman decoding processing (step S205g), dequantization processing (step S205b), deDCT processing (step S205c) and RGB conversion processing (step S205d) are conducted for the read out image data.

In such a manner, only irreversible data decompression processings (dequantization processing, deDCT processing and RGB conversion processing) are applied to the image data which is stored in the working area of the image memory 262 prior to Huffman coding. In the second and subsequent copies, the image data after the Huffman coding, which is stored in the storage area of the image memory 262 is subjected to reversible data compression processing (Huffman decoding) and irreversible data decompression (dequantization, deDCT processing, RGB conversion processing).

Since the reversible data decompression processing (Huffman decoding, step S205g) is omitted in the decompression processing for the first copy (step S205) in the reproduction in the image forming apparatus of example 4, shortening of the first copy time can be achieved.

In accordance with the present invention, following advantages are provided.

Since each processing including compression, storage, decompression and image forming are sequentially conducted for the image data of a given portion of an original document each time when a given portion less than one page of the original document is read in accordance with the present invention, the first copy time can be shortened.

Since the image forming for the first and second and subsequent copies is conducted based upon the decompressed image data which is obtained by the decompression of the irreversible compressed image data which is subjected to the irreversible compression process, there is no difference in image quality between all memory output copies. In other words, the all memory output copies are preferably equal in image quality.

By configuring the image data compressing portion, image data storing portion, and image data decompressing portion so that they are operated in parallel like the image forming apparatus of the present invention, the first copy time can be further shortened.

1. An image forming apparatus having a storage portion for storing image data, which is capable of reproducing a plurality of copies of an original document by reading the original document once by conducting image forming based upon the image data stored in the storage portion, comprising:
an image data compressing portion for sequentially applying at least irreversible compression processing to the image data of a given portion of the original document, which is obtained each time when the given portion of the original document less than one page thereof is read;
an image data storing portion for sequentially storing in the storage portion irreversible compressed image data which is obtained by sequentially applying the irreversible compression processing to the image data of the given portion by means of the image data compressing portion;
an image data decompressing portion for sequentially decompressing the irreversible compressed image data which is sequentially stored in the storage portion by the image data storing portion; and
an image forming portion for sequentially forming images on a sheet of paper based upon the decompressed image data which is obtained by sequentially decompressing the irreversible compressed image data by the image data decompressing portion;
wherein the image data compressing portion, the image data storing portion and the image data decompressing portion are operated in parallel.

2. An image forming apparatus having a storage portion for storing image data, which is capable of reproducing a plurality of copies of an original document by reading the original document once by conducting image forming based upon the image data stored in the storage portion, comprising:
an image data compressing portion for sequentially applying at least irreversible compression processing to the image data of a given portion of the original document, which is obtained each time when the given portion of the original document less than one page thereof is read;
an image data storing portion for sequentially storing in the storage portion irreversible compressed image data which is obtained by sequentially applying the irreversible compression processing to the image data of the given portion by means of the image data compressing portion;
an image data decompressing portion for sequentially decompressing the irreversible compressed image data which is sequentially stored in the storage portion by the image data storing portion;
a storing and decompression processing portion which conducts the storing of the image data by the image data storing portion and the decompression of the image data by the image data decompressing portion in parallel for the irreversible compressed image data which is obtained by the image data compressing portion; and
an image forming portion for sequentially forming images on a sheet of paper based upon the decompressed image data which is obtained by sequentially decompressing the irreversible compressed image data by the image data decompressing portion;
wherein the image data compressing portion and the storing and decompression processing portion are operated in parallel.

3. The image forming apparatus as defined in claim 1 or 2, wherein the image data compressing portion conducts the irreversible compression processing and a reversible compression processing for reversibly compressing the irreversible compressed image data which is obtained by sequentially applying the irreversible compression processing to the image data of the given portion of the original document.

4. The image forming apparatus as defined in claim 1 or 2, wherein the irreversible compression processing sequentially executes YUV transform processing, DCT processing and quantization processing.

5. The image forming apparatus as defined in claim 3, wherein the reversible compression processing is Huffman coding processing.

6. An image forming process for conducting reproduction of a plurality of copies of an original document by reading the original document once by conducting the image forming based upon the image data stored in a storage portion, wherein
a first reproduction step for reproducing a first copy of the original document comprises an image data compressing step for sequentially applying at least an irreversible compression processing to the image data of a given portion of the original document which is obtained each time when the given portion of the original document less than one page thereof is read; an image data storing step for sequentially storing in the storage portion irreversible compressed image data which is obtained by sequentially applying the irreversible compression processing to the image data of the given portion of the original document by the image data compressing step; an image data decompressing step for sequentially decompressing the irreversible compressed image data which is sequentially stored in the storage portion by the image data storing step; and an image forming step for sequentially forming images on a sheet of paper based upon decompressed image data which is obtained by sequentially decompressing the irreversible compressed image data by the image data decompressing step; and
a second reproduction step for reproducing second and subsequent copies of the original document comprises the image data decompressing step and the image forming step.

7. The image forming process as defined in claim 6, wherein the image data compressing step conducts the irreversible compression processing and reversible compression processing for further reversibly compressing the irreversible compressed image data which is obtained by sequentially applying the irreversible compression processing to the image data of the given portion of the original document.

8. The image forming process as defined in claim 6 or 7, wherein the irreversible compression processing sequentially conducts YUV transform processing, DCT processing and quantization processing.

9. The image forming process as defined in claim 7, wherein the reversible compression processing is Huffman coding processing.

10. The image forming process as defined in claim 6, wherein the image data decompressing step in the first reproduction step sequentially conducts a dequantization processing, deDCT processing and RGB conversion processing; and
the image data decompressing step in the second reproduction step is performed by sequentially conducting Huffman decoding processing, dequantization processing, deDCT processing and RGB conversion processing.

11. An image forming program performed by computer for conducting reproduction of a plurality of copies of an original document by reading the original document once by conducting the image forming based upon the image data stored in a storage portion, wherein
a first module for conducting reproduction of a first copy of the original document comprises an image data compressing module for sequentially applying at least an irreversible compression processing to the image data of a given portion of the original document which is obtained each time when the given portion of the original document less than one page thereof is read; an image data storing module for sequentially storing in the storage portion irreversible compressed image data which is obtained by sequentially applying the irreversible compression processing to the image data of the given portion of the original document by the image data compressing module; an image data decompressing module for sequentially decompressing the irreversible compressed image data which is sequentially stored in the storage portion by the image data storing module; and an image forming module for sequentially forming images on a sheet of paper based upon decompressed image data which is obtained by sequentially decompressing the irreversible compressed image data by the image data decompressing module; and
a second reproduction module for reproducing second and subsequent copies of the original document comprises the image data decompressing module and the image forming module.
